(19) United States
(12) Patent Application Publication
(10) Pub. No.: US 2025/0181216 A1
(43) Pub. Date: Jun. 5, 2025

(54) INFORMATION DISPLAY METHOD AND APPARATUS, AND HEAD-MOUNTED DISPLAY DEVICE, AND STORAGE MEDIUM

(71) Applicant: Beijing Zitiao Network Technology Co., Ltd., Beijing (CN)

(72) Inventors: Chi FANG, Beijing (CN); Yiping YANG, Beijing (CN); Na PANG, Beijing (CN); Xiaolin LI, Beijing (CN); Can WANG, Beijing (CN)

(21) Appl. No.: 18/842,292

(22) PCT Filed: Feb. 20, 2023
(86) PCT No.: PCT/CN2023/077210

§ 371 Date: Aug. 28, 2024

(30) Foreign Application Priority Data
Mar. 4, 2022 (CN) 202210207263.4

(51) Int. Cl. G06F 3/0484; G06F 3/04815; G06T 19/00

(52) U.S. Cl. CPC G06F 3/0484; G06F 3/04815; G06T 19/006; G06T 2200/24

(57) ABSTRACT

The present disclosure relates to an information presentation method and apparatus, a head-mounted display device, and a storage medium. The method includes: entering a virtual reality space; receiving a media playing instruction triggered by a user, and displaying a playing page of a target multimedia file in the virtual reality space; presenting a playing controlling panel in the virtual reality space, wherein the playing controlling panel includes a control region and a non-control region; and presenting, in the non-control region, information related to the multimedia file. According to the technical solutions provided by the embodiments of the present disclosure, the target multimedia file is played by virtue of the playing page, and the playing controlling panel is used to perform playing control on the target multimedia file and present the related information.

### CROSS-REFERENCE TO RELATED APPLICATION(S)

This application claims priority to Chinese Patent Application No. “202210207263.4”, entitled “INFORMATION DISPLAY METHOD AND APPARATUS, AND HEAD-MOUNTED DISPLAY DEVICE, AND STORAGE MEDIUM”, filed on Mar. 4, 2022, which is incorporated by reference in its entirety.

### FIELD

The present disclosure relates to the technical field of virtual realities, and in particular, to an information presentation method and apparatus, a head-mounted display device, and a storage medium.

### BACKGROUND

A Virtual Reality (VR) technology is a computer simulation system that may create and experience a virtual world. It is a simulated environment generated by a computer, an interactive three-dimensional dynamic scene and entity behavior simulation system that integrates multi-source information, and a simulation system that uses entity behaviors.

With the continuous improvement of technology, there is an increasing demand for using the VR technology for multimedia information presentation. However, how to use the VR technology for comprehensive presentation of multimedia information is still a problem urgently needing to be solved.

### SUMMARY

In order to solve the above technical problems, the present disclosure provides an information presentation method and apparatus, a head-mounted display device, and a storage medium.

In a first aspect, the present disclosure provides an information presentation method. The method is applied to an extended reality (XR) terminal device. The method includes:

entering a virtual reality space;

receiving a media playing instruction triggered by a user to display a playing page of a target multimedia file in the virtual reality space;

presenting a playing controlling panel in the virtual reality space, and the playing controlling panel includes a control region and a non-control region; and

presenting, in the non-control region, information related to the multimedia file.

In a second aspect, the present disclosure further provides an information presentation apparatus. The apparatus is applied to an XR terminal device. The apparatus includes:

an entering module, configured to enter a virtual reality space;

a first presentation module, configured to receive a media playing instruction triggered by a user to display a playing page of a target multimedia file in the virtual reality space;

a second presentation module, configured to present a playing controlling panel in the virtual reality space, and the playing controlling panel includes a control region and a non-control region; and

a third presentation module, configured to present, in the non-control region, information related to the multimedia file.

In a third aspect, the present disclosure further provides a head-mounted display device. The head-mounted display device includes:

one or more processors;

a memory apparatus, configured to store one or more programs,

wherein the one or more programs, when run by the one or more processors, cause the one or more processors to implement the above-mentioned information presentation method.

In a fourth aspect, the present disclosure further provides a computer-readable medium, having a computer program stored thereon, wherein the program, when run by a processor, implements the above-mentioned information presentation method.

Compared with the related art, the technical solutions provided by the embodiments of the present disclosure have the following advantages:

According to the technical solutions provided by the embodiments of the present disclosure, when a media playing instruction triggered by a user is received, a playing page of a target multimedia file is displayed in a virtual reality space: a playing controlling panel is presented in the virtual reality space, the virtual reality space including a control region and a non-control region: and information related to the multimedia file is presented in the non-control region. Actually, the target multimedia file is played by virtue of the playing page, and the playing controlling panel is used to perform playing control on the target multimedia file and present the related information, so that such a setting may achieve comprehensive presentation of multimedia information.

### BRIEF DESCRIPTION OF THE DRAWINGS

The drawings here are incorporated into and form part of the specification, showing the embodiments that comply with the present disclosure, and are used together with the specification to explain the principles of the present disclosure.

In order to describe the technical solutions in the embodiments of the present disclosure or in the related art more clearly, the following briefly introduces the accompanying drawings for describing the embodiments or the related art. Apparently, a person of ordinary skill in the art may still derive other drawings from the accompanying drawings without creative effort.

FIG. 1 is a flowchart of an information presentation method provided by an embodiment of the present disclosure;

FIG. 2 is a flowchart of another information presentation method provided by an embodiment of the present disclosure;

FIG. 3 is a schematic diagram of a playing controlling panel provided by an embodiment of the present disclosure;

FIG. 4 is a schematic diagram of another playing controlling panel provided by an embodiment of the present disclosure;

FIG. 5 is a schematic diagram of control rendering provided by an embodiment of the present disclosure;

FIG. 6 is a flowchart of another information presentation method provided by an embodiment of the present disclosure;

FIG. 7 and FIG. 8 are schematic diagrams of another playing controlling panel provided by an embodiment of the present disclosure;

FIG. 9 and FIG. 10 are schematic diagrams of another playing controlling panel provided by an embodiment of the present disclosure;

FIG. 11 is a schematic diagram of another playing controlling panel provided by an embodiment of the present disclosure;

FIG. 12 is a schematic diagram of a Cube model provided by an embodiment of the present disclosure;

FIG. 13 is a schematic structural diagram of an information presentation apparatus in an embodiment of the present disclosure; and

FIG. 14 is a schematic structural diagram of a head-mounted display device in an embodiment of the present disclosure.

### DETAILED DESCRIPTION OF EMBODIMENTS

In order to better understand the above objectives, features, and advantages of the present disclosure, the following will further describe the solutions of the present disclosure. It should be noted that the embodiments of the present disclosure and features in the embodiments may be mutually combined without conflicts.

Many specific details have been elaborated in the following description to facilitate a full understanding of the present disclosure, but the present disclosure can also be implemented in other ways different from those described here. Obviously, the embodiments in the specification are only part of the embodiments of the present disclosure, rather than all the embodiments.

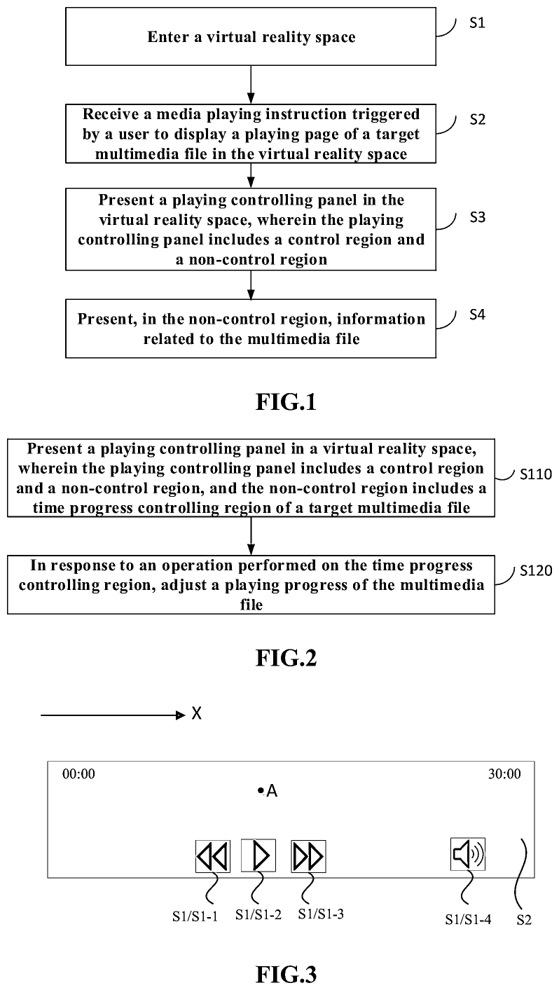

FIG. 1 is a flowchart of an information presentation method provided by an embodiment of the present disclosure. The method is applied to an extended reality XR terminal device. The method includes:

S1. Enter a virtual reality space.

S2. A media playing instruction triggered by a user is received, and a playing page of a target multimedia file is displayed in the virtual reality space.

The playing page is used for playing the target multimedia file.

S3. A playing controlling panel is presented in the virtual reality space, and the playing controlling panel includes a control region and a non-control region.

The control region is used for deploying controls, and the deployed controls may be at least one of the following: a play/pause control, a volume adjustment control, a fast forward control, a fast rewind control, and a viewing mode selection control.

The non-control region is used for presenting related information of the target multimedia file. The related information of the multimedia file includes playing progress information, content introduction information, associated content recommendation information, comment information, advertising information, and selection information.

In practice, there are various layout modes for the control region and the non-control region, and the present application does not limit this. Alternatively, the control region includes at least two control sub-regions. Any two control sub-regions are not connected. At least one control is arranged in each of the control sub-regions. Or, the non-control region and the control region are arranged on at the top and bottom or on the left and right.

Further, the non-control region includes at least one of the following regions: a time progress controlling region, content introduction region, associated content recommendation region, comment region, an advertising region, and selection menu region of the target multimedia file. The time progress controlling region is used for presenting a playing progress of the current target multimedia file. In addition, the playing progress of the target multimedia file may be adjusted by operating the time progress controlling region. The essence of this setting is to divide the non-control region according to the type of related information of the multimedia file to form a plurality of non-control sub-regions. Each of the non-control sub-regions is only used for presenting one type of information. The types of the information presented in different non-control sub-regions are different.

Alternatively, in practice, after the media playing instruction triggered by the user is received, the playing page and playing controlling panel of the target multimedia file can be simultaneously displayed. After a playing controlling panel presentation instruction is received, the playing controlling panel is presented in the virtual reality space. Alternatively, the playing page and the playing controlling panel are located on different spatial planes of the virtual reality space, or in different position regions on the same plane in the virtual reality space. The embodiments of the present disclosure do not impose too many restrictions on this. For example, positions and orientations of the playing page and the playing controlling panel in the virtual reality space can be set based on a viewing distance of a user. For example, a distance between the playing page of the target multimedia file and the user is longer than the distance between the playing controlling panel and the user.

S4. Information related to the multimedia file is presented in the non-control region.

According to the technical solutions, when a media playing instruction triggered by a user is received, a playing page of a target multimedia file is displayed in a virtual reality space; a playing controlling panel is presented in the virtual reality space, the virtual reality space including a control region and a non-control region; and information related to the multimedia file is presented in the non-control region. Actually, the target multimedia file is played by virtue of the playing page, and the playing controlling panel is used to perform playing controlling on the target multimedia file and present the related information, so that such a setting can achieve comprehensive presentation of multimedia information.

Based on the above technical solutions, alternatively, when a preset operation performed on a target region in the non-control region is detected, all the other regions of the playing controlling panel are forbidden to make feedback, and a response region of the target region is expanded to respond to a user operation performed on the target region.

Among them, a region of the playing controlling panel is forbidden to make feedback, which means that when a ray focus stays in or passes through the region, the region does not respond to the staying or passing action. Exemplarily, when a preset operation (such as a click operation, a hover operation, or a drag operation) performed on the time progress controlling region is detected, the time progress controlling region is a target region, and all controls in the control region are disabled. Meanwhile, the content introduction region, the related content recommendation region, the comment region, the advertising region, and the selection menu region are forbidden to make feedback, which may fully avoid touching by mistake. In addition, when the preset operation (such as the click operation, the hover operation, or the drag operation) performed on the time progress controlling region is detected, an area of the time progress controlling region is further adjusted to increase a degree of freedom of operating the time progress controlling region, so that it is easy to achieve the adjustment on the playing progress.

In another embodiment, alternatively, when a preset operation is detected, the playing controlling panel is switched to a control region that only includes a single function. Exemplarily, it is assumed that a playing controlling panel includes a control region and a non-control region, and the non-control region includes a time progress controlling region, content introduction region, associated content recommendation region, comment region, advertising region, and selection menu region of the target multimedia file. When a preset operation (such as a click operation, a hover operation, or a drag operation) performed on the time progress controlling region is detected, the playing controlling panel is switched to a playing controlling panel that only includes the time progress controlling region. This setting can fully avoid touching by mistake.

FIG. 2 is a flowchart of another information presentation method provided by an embodiment of the present disclosure. FIG. 2 is a specific example of FIG. 1. The solution in FIG. 2 is suitable for adjusting the playing progress of the target multimedia file by using the playing controlling panel. Furthermore, in the technical solution of FIG. 2, the non-control region of the playing controlling panel only includes the time progress controlling region of the target multimedia. As shown in FIG. 2, the method may specifically include:

S110. A playing controlling panel is presented in a virtual reality space, and the playing controlling panel includes a control region and a non-control region. The non-control region includes a time progress controlling region of a target multimedia file.

The control region is used for deploying controls, and the deployed controls may be at least one of the following: a play/pause control, a volume adjustment control, a fast forward control, a fast rewind control, and a viewing mode selection control.

The time progress controlling region is used as a hot region for adjusting a playing progress and is used for receiving an operation action of a user. Subsequently, a playing progress adjustment instruction may be formed based on an operation action input by a user to adjust the playing progress. In addition, the time progress controlling region may be further used for presenting related information of a multimedia file, such as the name of the multimedia file, a total duration of the multimedia file, a duration that the multimedia file has been played, a subtitle of the multimedia file, and the like.

In practice, there are various layout modes for the control region and the non-control region, and the present application does not limit this. Alternatively, the control region includes at least two control sub-regions. Any two control sub-regions are not connected. At least one control is arranged in each of the control sub-regions. FIG. 3 is a schematic diagram of a playing controlling panel provided by an embodiment of the present disclosure. Referring to FIG. 3 the playing controlling panel includes a control region S1 and a non-control region S2. The control region S1 includes four control sub-regions, namely S1-1, S1-2, S1-3, and S1-4. Only one control is arranged in each of the control sub-regions. The four control sub-regions are arranged in the non-control region S2 in a spacing and dispersed manner. A sum of an area of control region S1 and an area of non-control region S2 is equal to a total area of the playing controlling panel.

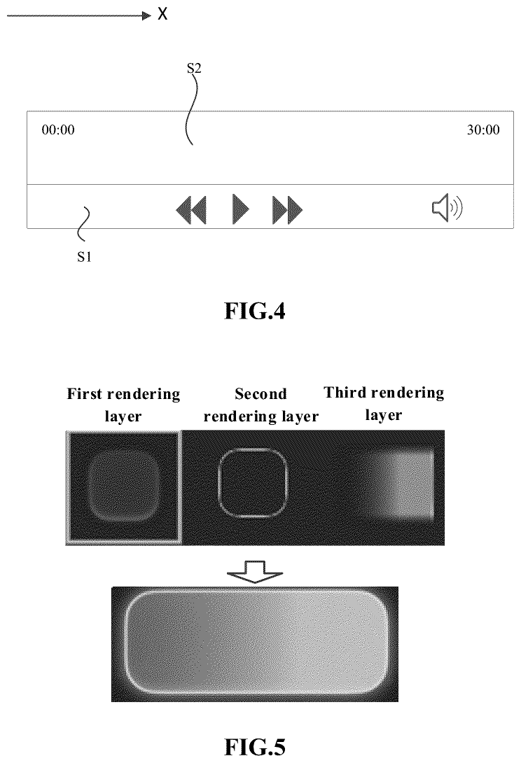

Or, alternatively, the non-control region and the control region are arranged on at the top and bottom or on the left and right. At least one control is arranged in the control region. FIG. 4 is a schematic diagram of another playing controlling panel provided by an embodiment of the present disclosure. As shown in FIG. 4, a control region S1 is located below a non-control region S2, and a plurality of controls are arranged in the control region. A sum of an area of control region S1 and an area of non-control region S2 is equal to a total area of the playing controlling panel.

It should be noted that in FIG. 4, the plurality of controls is arranged side by side in the control region. This is only a specific example of the present application and not a limitation on the present application. In practice, the plurality of controls may be arranged in any way in the control region.

Alternatively, in practice, at least one control may be set to have a rounded polygon shape. Furthermore, edges of the control have a color gradient effect. In a specific implementation, the Unity3D shader may be used to form rounded corners of the control. Specifically, a proportion of the rounded corners is preset; whether pixels are in the rounded corners; if a pixel is in a rounded corner, the pixel is maintained; and otherwise, the pixel is discarded. Since the edges of the control have the color gradient effect, the jagged sensation of the rounded corners can be eliminated, and the aesthetics of the control is improved.

Alternatively, to further highlight the control, a rim of the control may present a glowing effect. In specific implementation, a plurality of rendering layers may be used to stacked. FIG. 5 is a schematic diagram of control rendering provided by an embodiment of the present disclosure. Referring to FIG. 5, three rendering layers are set for a control. The first rendering layer and the second rendering layer are used for rendering a background, and the second rendering layer is used for rendering a rim. The three rendering layers are stacked to obtain a control with a rim having a glowing effect.

S120. In response to an operation performed on the time progress controlling region, a playing progress of the multimedia file is adjusted.

There are various implementation methods for this step. Exemplarily, the implementation method of this step includes: In response to a pressing operation performed on the time progress controlling region of the target multimedia file, a pressing position is obtained; a target playing position corresponding to the pressing position is determined: and the multimedia file is played by taking the target playing position as a start point.

In practice, the pressing operation may be a click operation or a drag operation. Specifically, if a duration of the pressing operation is short and an operation distance is short, the pressing operation is the click operation. If the duration of the pressing operation is long and the operation distance is long, the pressing operation is the drag operation. Therefore, in practice, a specific type of the pressing operation may be determined based on the duration and/or operation distance (namely, a drag distance) of the pressing operation.

Alternatively, a specific implementation method of this step may be as follows: In response to the pressing operation performed on the time progress controlling region of the target multimedia file, an operation distance of the pressing operation is determined: if the operation distance of the pressing operation is less than a distance threshold, information of a pressing position at initial time of the pressing operation is obtained, and a target playing position corresponding to the pressing position at the initial time of the pressing operation is determined; if the operation distance of the pressing operation is greater than or equal to the distance threshold, information of a pressing position at end time of the pressing operation is obtained, and a target playing position corresponding to the pressing position at the end time of the pressing operation is determined; and the multimedia file is played by taking the target playing position as a start point.

Alternatively, the operation distance of the pressing operation means a projection length of a movement trajectory of a ray focus in an X-axis direction during a time period from the start time to the end time of the pressing operation. An X-axis is parallel to a lengthwise direction of the playing controlling panel.

If the operation distance of the pressing operation is less than the distance threshold, the pressing operation is determined as the click operation. Since the operation distance of the click operation is very short, it may be considered that the ray focus does not move throughout the entire operation process. Therefore, the pressing position at the initial time of the pressing operation is used to represent the intention of a user to adjust the progress. If the operation distance of the pressing operation is greater than or equal to the distance threshold. the pressing operation is determined as the drag operation. In the drag operation, the position at the end time (namely, the end time of the pressing operation) of the drag operation is used to represent the intention of a user to adjust the progress.

In this way, regardless of whether the pressing operation is the click operation or the drag operation, the playing progress of the multimedia file is only adjusted once in each pressing operation.

There are various methods for implementing “a target playing position corresponding to the pressing position at the initial time of the pressing operation is determined”, and the present application does not limit this. Exemplarily, a left side line of the playing controlling panel is set to correspond to start time of playing of the multimedia file, and the right side line of the playing controlling panel is set to correspond to end time of playing of the multimedia file. A first distance between the pressing position at the initial time of the pressing operation and a straight line where the left side line of the playing controlling panel is located is determined. The target playing position is determined based on the first distance, a total length of the playing controlling panel, and a total duration of the currently presented multimedia file. Or, the X-axis is set to be parallel to the lengthwise direction of the playing controlling panel. A coordinate value of the left side line of the playing controlling panel on the X-axis is m, and a coordinate value of the right side line of the playing controlling panel on the X-axis is n. A correspondence relationship between any point in an interval (m, n) and playing time of the currently presented multimedia file is determined. Target playing time (namely, the target playing position) is determined according to a coordinate value of the pressing position at the initial time of the pressing operation on the X-axis and the correspondence relationship.

The method for implementing “a target playing position corresponding to the pressing position at the end time of the pressing operation is determined” is similar to the method for implementing “a target playing position corresponding to the pressing position at the initial time of the pressing operation is determined”, and will not be elaborated here.

Alternatively, in practice, the step “an operation distance of the pressing operation is determined” may be executed at the end of the pressing operation or during the pressing operation. If the step is executed during the pressing operation, alternatively, the step “an operation distance of the pressing operation is determined” may be performed periodically until the operation distance of the pressing operation is greater than or equal to the distance threshold (the pressing operation is the drag operation), or until the pressing operation ends (the pressing operation is the click operation).

In practice, a drag operation may be regarded as extension of a click operation. Therefore, the implementation of this step may also be as follows: In response to the pressing operation performed on the time progress controlling region, an operation distance of the pressing operation is determined, information of a pressing position at initial time of the pressing operation is obtained, and a first target playing position corresponding to the pressing position at the initial time of the pressing operation is determined; the multimedia file is played by taking the first target playing position as a start point; whether the operation distance of the pressing operation is greater than or equal to the distance threshold is determined; if yes, information of a pressing position at end time of the pressing operation is obtained, and a second target playing position corresponding to the pressing position at the end time of the pressing operation is determined; and the multimedia file is played by taking the second target playing position as a start point. In this case, the step “an operation distance of the pressing operation is determined” is performed periodically during the pressing operation until the operation distance of the pressing operation is greater than or equal to the distance threshold (the pressing operation is the drag operation), or until the pressing operation ends (the pressing operation is the click operation).

The essence of this setting is that if the operation distance of the pressing operation is less than the distance threshold, “information of a pressing position at end time of the pressing operation is obtained; a second target playing position corresponding to the pressing position at the end time of the pressing operation is determined; and the multimedia file is played by taking the second target playing position as a start point” is not performed, that is, after the multimedia file starts to be played at the first target playing position, the playing progress will no longer adjusted. If the operation distance of the pressing operation is greater than or equal to the distance threshold, “information of a pressing position at end time of the pressing operation is obtained; a second target playing position corresponding to the pressing position at the end time of the pressing operation is determined; and the multimedia file is played by taking the second target playing position as a start point” is performed, that is, after the multimedia file starts to be played at the first target playing position, the playing progress will be adjusted again according to the second target playing position. In this way, if the pressing operation is the click operation, the playing progress of the multimedia file is adjusted once in each pressing operation. if the pressing operation is the drag operation, the playing progress of the multimedia file is adjusted twice in each pressing operation.

Alternatively, in practice, the step of “determining an operation distance of the pressing operation” may be executed at the end of the pressing operation or during the pressing operation. If the step is executed during the pressing operation, alternatively, the step “an operation distance of the pressing operation is determined” may be performed periodically until the operation distance of the pressing operation is greater than or equal to the distance threshold (the pressing operation is the drag operation), or until the pressing operation ends (the pressing operation is the click operation).

According to the above technical solutions, the playing progress of the multimedia file is adjusted in response to the operation performed on the time progress controlling region of the target multimedia. In practice, there is no progress bar set in the playing controlling panel, and the time progress controlling region in the non-control region of the playing controlling panel is used as a hot region for adjusting a playing progress of a multimedia file, to receive an operation performed by a user for adjusting the playing progress. Due to a large size of the time progress controlling region of the target multimedia, the degree of freedom of clicking and dragging can be increased, making it easy to adjust the playing progress.

It should be noted that under normal circumstances, interactions between a user and a head-mounted display device is achieved through collision between a ray and a collision box. In a three-dimensional scene, the collision between the ray and the collision box may generate a three-dimensional coordinate. The three-dimensional coordinate is a position rendered by a cursor. However, in a multimedia file playing scene, the playing controlling panel is presented on a plane, so no three-dimensional collision box needs to be generated for the controls in the playing controlling panel. A two-dimensional collision box may be generated for the controls in the playing controlling panel. That is, a two-dimensional coordinate system is constructed on the plane where the playing controlling panel is located. When the pressing operation is processed, only coordinate values of the ray focus in the two-dimensional coordinate system are paid attention to.

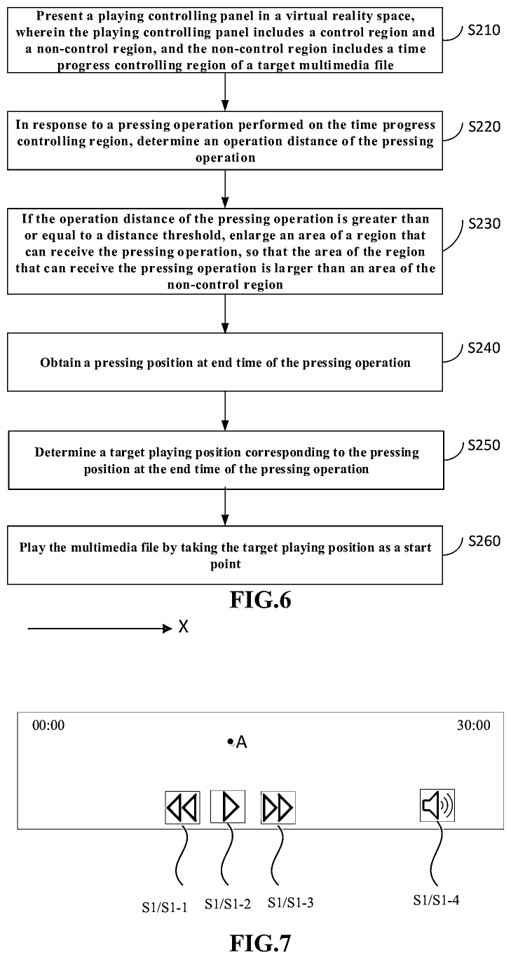

FIG. 6 is a flowchart of another information display method provided in this disclosed embodiment. FIG. 6 is a specific example in FIG. 2. The technical solution shown in FIG. 6 is suitable for adjusting the playing progress in a dragging manner. Referring to FIG. 6, the method includes:

S210. A playing controlling panel is presented in a virtual reality space, wherein the playing controlling panel includes a control region and a non-control region. The non-control region includes a time progress controlling region of a target multimedia file.

S220. In response to a pressing operation performed on the time progress controlling region, an operation distance of the pressing operation is determined.

Specifically, in response to the pressing operation performed on the time progress controlling region of the target multimedia, the operation distance of the pressing operation is periodically determined during the pressing operation.

S230. If the operation distance of the pressing operation is greater than or equal to a distance threshold, an area of a region that can receive the pressing operation is expanded, so that the area of the region that may receive the pressing operation is larger than an area of the time progress controlling region.

Alternatively, the playing controlling panel is located in the region that can receive the pressing operation.

FIG. 7 and FIG. 8 are schematic diagrams of another playing controlling panel provided by an embodiment of the present disclosure. Exemplarily, when a user puts a ray focus at position A in FIG. 7 through a gamepad and presses a selection button in the gamepad, since position A is located in the time progress controlling region, it is confirmed that the operation performed by the user belongs to a pressing operation performed on the time progress controlling region. An operation distance of the pressing operation is periodically determined. If the operation distance of the pressing operation is greater than or equal to a distance threshold at time t, it is determined that the pressing operation is a drag operation. An area of a region that can receive the pressing operation is expanded, namely, a hot region that can be dragged is expanded. In FIG. 8, a region filled with dots represents a hot region that can be dragged after being expanded. This setting may increase the degree of freedom of drag controlling and effectively improve the controllability and efficiency of the drag operation. It needs to be emphasized that the pressing operation does not end at time t.

S240. A pressing position at end time of the pressing operation is obtained.

S250. A target playing position corresponding to the pressing position at the end time of the pressing operation is determined.

There are various implementation methods for this step, and the present application does not limit this. Exemplarily, an X-axis is set to be parallel to a lengthwise direction of the playing controlling panel. A coordinate value of a left side line of the region that can receive the pressing operation on the X-axis is p, and a coordinate value of the right side line of the region that can receive the pressing operation on the X-axis is q. A correspondence relationship between any point in an interval (p, q) and playing time of the currently presented multimedia file is determined. Target playing time (namely, the target playing position) is determined according to a coordinate value of the pressing position at the end time of the pressing operation (namely, the end time of the drag operation) on the X-axis and the correspondence relationship.

Or, alternatively, continuing to refer to FIG. 8, the region that can receive the pressing operation can be divided into three regions, namely a first hot sub-region S2-1, a second hot sub-region S2-2, and a third hot sub-region S2-3 arranged in sequence from left to right. An intersection line of the first hot sub-region S2-1 and the second hot sub-region S2-2 passes through the left side line of the playing controlling panel, and an intersection line of the second hot sub-region S2-2 and the third hot sub-region S2-3 passes through the right side line of the playing controlling panel. A specific implementation method of this step includes: If the pressing position (e.g., the pressing position is point C, point H, or point E in FIG. 8) at the end time of the pressing operation is located in the second hot sub-region, the target playing position corresponding to the pressing position is determined based on a coordinate value of the pressing position at the end time of the pressing operation in an X-axis direction; if the pressing position (e.g., the pressing position is point B or point F in FIG. 8) at the end time of the pressing operation is located in the first hot sub-region, it is determined that the start time of the multimedia file is the target playing position corresponding to the pressing position; and if the pressing position (e.g., the pressing position is point D or point G in FIG. 8) at the end time of the pressing operation is located in the third hot sub-region, it is determined that the end time of the multimedia file is the target playing position corresponding to the pressing position.

If the pressing position at the end time of the pressing operation is located in the second hot sub-region, the target playing position corresponding to the pressing position is determined based on a coordinate value of the pressing position at the end time of the pressing operation in an X-axis direction. A specific implementation method for the above step is similar to the method for implementing “the target playing position corresponding to the pressing position at the initial time of the pressing operation” mentioned above, and will not be elaborated here.

S260. The multimedia file is played by taking the target playing position as a start point.

According to the essence of the above technical solution, if the pressing operation is the drag operation, the area of the region that can receive the pressing operation is expanded to increase the degree of freedom of drag controlling and effectively improve the controllability and efficiency of the drag operation.

Based on the various technical solutions described above, alternatively, if the operation distance of the pressing operation is greater than or equal to the distance threshold, the controls located in the control region are disabled until the pressing operation ends. The purpose of this setting is to prevent the controls in the control region from making responses to the hover, click, and drag operations during the drag operation, so as to avoid mis-touch.

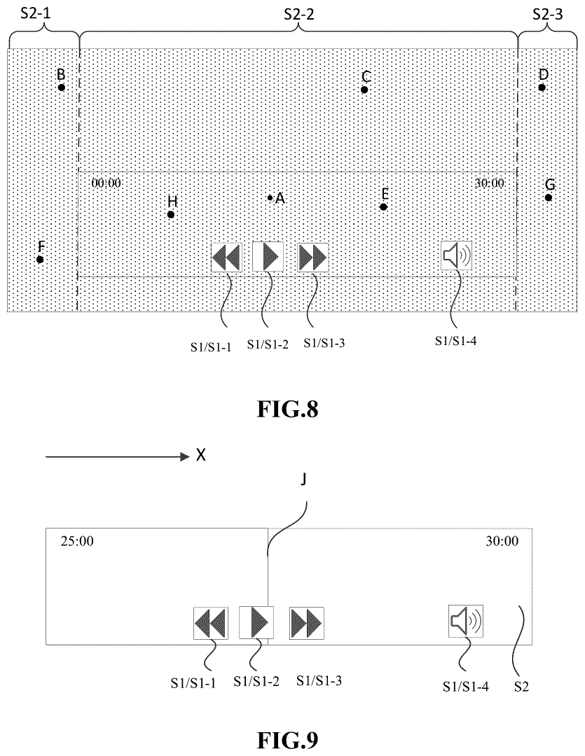

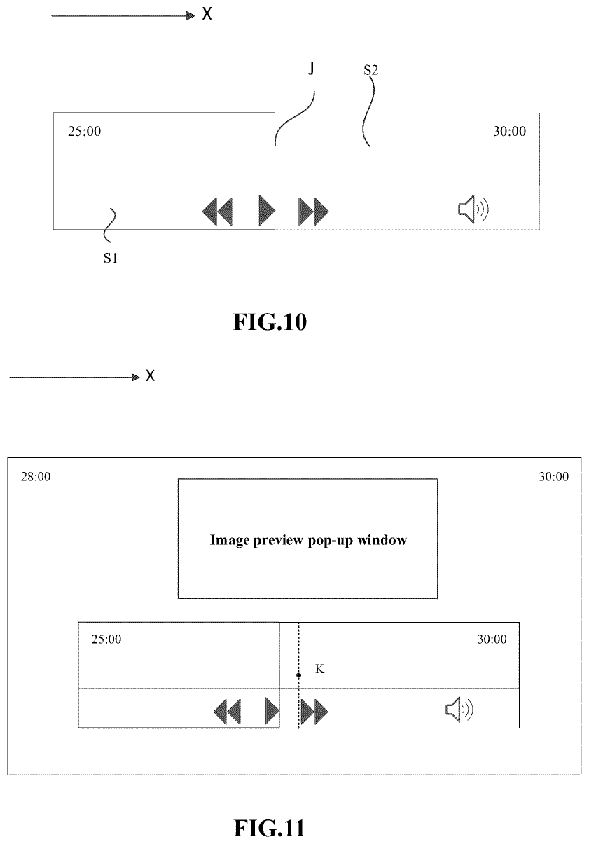

FIG. 9 and FIG. 10 are schematic diagrams of another playing controlling panel provided by an embodiment of the present disclosure. Based on the various technical solutions described above, alternatively, the method further includes: A current progress identifier is presented in the playing controlling panel. In FIG. 9 and FIG. 10, a vertical line labeled J and perpendicular to the X-axis is the current progress identifier.

Further, if the pressing operation is a click operation, a coordinate value of the current progress identifier on the X-axis is the same as the coordinate value of the pressing position at the start time of the pressing operation on the X-axis. If the pressing operation is used as a drag operation, a coordinate value of the current progress identifier on the X-axis is the same as the coordinate value of the pressing position at the end time of the pressing operation on the X-axis.

Alternatively, continuing to refer to FIG. 9 and FIG. 10, in the playing controlling panel, a background color of a region between the current progress identifier J and the left side line of the playing controlling panel is different from a background color of a region between the current progress identifier J and the right side line of the playing controlling panel. This setting is beneficial for highlighting information of the playing progress of the multimedia file at current time.

Further, the method further includes: In response to a hover operation performed on the time progress controlling region of the target multimedia file, information of a hover position is obtained; a video image corresponding to the hover position and time information of the video image are determined; and the video image and the time information of the video image are presented in the plane where the playing controlling panel is located.

FIG. 11 is a schematic diagram of another playing controlling panel provided by an embodiment of the present disclosure. Referring to FIG. 11, it is assumed that the ray focus hovers over point K, and a video image corresponding to point K is presented in an image preview pop-up window. The image preview pop-up window is located in the plane where the playing controlling panel is located.

Alternatively, when a head-mounted display device is used to play a video, if a projection mode of a video source to be played is a full screen mode (i.e. Plane in a 2D mode), and a length-width ratio of a video image in the video source is different from a length-width ratio of a video display region in the head-mounted display device, a center of the video image is aligned with a center of the video display region; the length-width ratio of the video image is maintained unchanged; and the video image is expanded until a width of the video image is consistent with a width of the video display region and a length of the video image is less than a length of the video display region; or, a center of the video image is aligned with a center of the video display region; the length-width ratio of the video image is maintained unchanged; and the video image is expanded until a length of the video image is consistent with a length of the video display region and a width of the video image is less than a width of the video display region. This setting can solve the problem of deformation of objects in the video image caused by stretching.

Further, if the multimedia file is a video, the method further includes: A projection mode and storage mode of video source data are determined; a video playing model corresponding to the video source is determined based on the projection mode and the storage mode, wherein the video playing model includes a video image pasting region; and each frame of video image in the video source data is pasted into the video image pasting region to form video data to be played. The projection mode includes Plane, Sphere, Cube, 360° panorama, 180° panorama, and the like. The storage mode includes ordinary (2D video), top and bottom (3D video), left and right (3D video), and other storage formats.

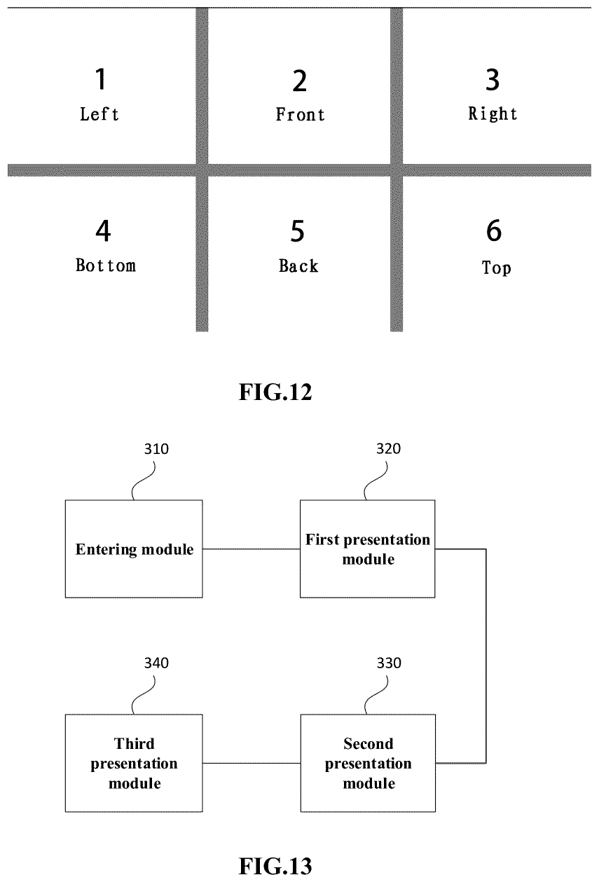

Exemplarily, FIG. 12 is a schematic diagram of a Cube model provided by an embodiment of the present disclosure. The Cube model includes six video image pasting regions, namely 1 left, 2 front, 3 right, 4 bottom, 5 back, and 6 top. Video source data is obtained from a browser playing kernel through Surface sharing; and the video source data is analyzed to obtain a projection mode and storage mode of the video source data. A video playing model, corresponding to the video source, in FIG. 11 is determined based on the projection mode and the storage mode of the video; and each frame of video image in the video source data is pasted to the video image pasting region in FIG. 11 to form video data to be played.

The above only takes the non-control region that includes the time progress controlling region of the target multimedia file as an example for interactive explanation and technical explanation. When the non-control region includes functions of one or a combination of the time progress controlling region, associated content recommendation region, comment region, advertising region, and selection menu region of the target multimedia file, the implementation and interaction are similar to the above description. However, when the non-control region only includes the functions of the combination, the non-control region is divided into corresponding functional regions. The embodiments of the present disclosure will not elaborate them one by one.

It should be noted that for the aforementioned various method embodiments, for the sake of simplicity, they are all described as a series of action combinations. However, those skilled in the art should be aware that the present invention is not limited by the order of the described actions, as according to the present invention, certain steps can be performed in other orders or simultaneously. Secondly, those skilled in the art should also be aware that the embodiments described in this specification are all preferred embodiments, and the actions and modules involved may not be necessary for the present invention.

FIG. 13 is a schematic structural diagram of an information presentation apparatus in an embodiment of the present disclosure. The apparatus is applied to an XR terminal device. Referring to FIG. 13, the information presentation apparatus specifically includes:

an entering module 310, configured to enter a virtual reality space;

a first presentation module 320, configured to receive a media playing instruction triggered by a user, and display a playing page of a target multimedia file in the virtual reality space;

a second presentation module 330, configured to present a playing controlling panel

in the virtual reality space, wherein the playing controlling panel includes a control region and a non-control region; and

a third presentation module 340, configured to present, in the non-control region, information related to the multimedia file.

Further, the control region includes at least two control sub-regions; any two control sub-regions are not connected; and at least one control is arranged in each of the control sub-regions.

Further, the non-control region and the control region are arranged on at the top and bottom or on the left and right.

Further, the non-control region at least includes one of the following regions;

a time progress controlling region, content introduction region, associated content recommendation region, comment region, advertising region, and selection menu region of the target multimedia file.

Further, when a preset operation performed on a target region in the non-control region is detected, all the other regions of the playing controlling panel are forbidden to make feedback, and a response region of the target region is expanded to respond to a user operation performed on the target region.

Further, the apparatus further includes a control module. The control module is configured to: when a preset operation is detected, switch the playing controlling panel to a control region that only includes a single function.

Further, if the multimedia file is a video, a projection mode of a video source is a full screen mode, and a length-width ratio of a video image in the video source is different from a length-width ratio of a video display region on the playing page of the target multimedia file,

the apparatus further includes a control module. The control module is configured to:

align a center of the video image with a center of the video display region, maintain the length-width ratio of the video image unchanged, and enlarge the video image until a width of the video image is consistent with a width of the video display region and a length of the video image is less than a length of the video display region; or,

align a center of the video image with a center of the video display region, maintain the length-width ratio of the video image unchanged, and enlarge the video image until a length of the video image is consistent with a length of the video display region and a width of the video image is less than a width of the video display region.

The playing progress adjustment apparatus provided by this embodiment of the present disclosure can execute the steps of the information presentation method provided by the method embodiments of the present disclosure, and has execution steps and beneficial effects, which will not be elaborated here.

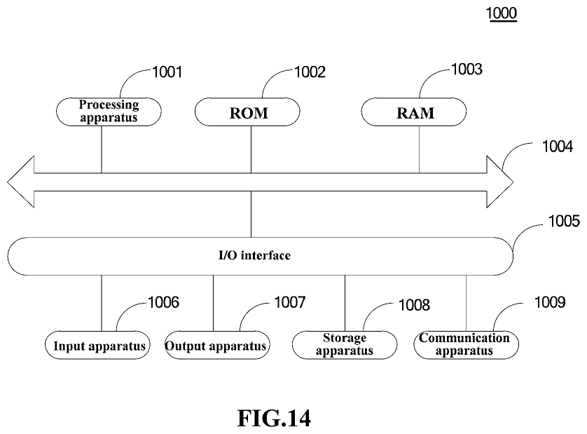

FIG. 14 is a schematic structural diagram of a head-mounted display device in an embodiment of the present disclosure. Specifically referring to FIG. 14 below; a schematic structural diagram of a head-mounted display device 1000 suitable for implementing the embodiments of the present disclosure is shown.

As shown in FIG. 14, the head-mounted display device 1000 may include a processing apparatus (such as a central processing unit and graphics processor) 1001 that can perform various appropriate actions and processing according to programs stored in a Read-Only Memory (ROM) 1002 or loaded from a storage apparatus 1008 to a Random Access Memory (RAM) 1003, so as to implement the information presentation method as described in the embodiments of the present disclosure. The RAM 1003 further stores various programs and information required for operations of the head-mounted display device 1000. The processing apparatus 1001, the ROM 1002, and the RAM 1003 are connected to each other through a bus 1004. An Input/Output (I/O) interface 1005 is also connected to the bus 1004.

Usually, following apparatuses can be connected to the I/O interface 1005; an input apparatus 1006 including a touch screen, a touchpad, a keyboard, a mouse, a camera, a microphone, an accelerometer, a gyroscope, and the like; an output apparatus 1007 including a Liquid Crystal Display (LCD), a speaker, a vibrator, and the like; a storage apparatus 1008 including a magnetic tape, a hard disk drive, and the like; and a communication apparatus 1009. The communication apparatus 1009 can allow the head-mounted display device 1000 to wirelessly or wiredly communicate with other devices to exchange information. Although FIG. 13 shows the head-mounted display device 1000 with various apparatuses, it should be understood that the head-mounted display device is not required to implement or have all the apparatuses shown, and can alternatively implement or have more or fewer apparatuses.

Particularly, according to the embodiments of the present disclosure, the process described in the reference flowchart above can be implemented as a computer software program. For example, the embodiments of the present disclosure include a computer program product, including a computer program carried on a non-transitory computer-readable medium, and the computer program includes program codes used for performing the methods shown in the flowcharts, thereby implementing the above-mentioned information presentation method. In such an embodiment, the computer program may be downloaded and installed from a network through the communication apparatus 1009, or installed from the memory 1008, or installed from the ROM 1002. When the computer program is executed by the processing apparatus 1001, the above-mentioned functions defined in the methods of the embodiments of the present disclosure are executed.

It should be noted that the computer-readable medium mentioned in the present disclosure can be a computer-readable signal medium, a computer-readable storage medium, or any combination of the computer-readable signal medium and the computer-readable storage medium. The computer-readable storage medium can be, for example, but not limited to, electric, magnetic, optical, electromagnetic, infrared, or semiconductor systems, apparatuses, or devices, or any combination of the above. More specific examples of the computer-readable storage medium may include, but are not limited to: an electrical connection with one or more wires, a portable computer disk, a hard disk drive, a RAM, a ROM, an Erasable Programmable Read Only Memory (EPROM) or flash memory, an optical fiber, a Compact Disc Read-Only Memory (CD-ROM), an optical storage device, a magnetic storage device, or any suitable combination of the above. In the present disclosure, the computer-readable storage medium may be any tangible medium that contains or stores a program, and the program can be used by or in combination with an instruction execution system, apparatus, or device. In the present disclosure, the computer-readable signal media may include information signals propagated in a baseband or as part of a carrier wave, which carries computer-readable program codes. The propagated information signals can be in various forms, including but not limited to: electromagnetic signals, optical signals, or any suitable combination of the above. The computer-readable signal medium may also be any computer-readable medium other than a computer-readable storage medium. The computer-readable signal medium can send, propagate, or transmit programs for use by or in combination with an instruction execution system, apparatus, or device. The program codes contained in the computer-readable medium can be transmitted using any suitable medium, including but are not limited to: a wire, an optical cable, a Radio Frequency (RF), and the like, or any suitable combination of the above.

In some implementations, clients and servers can communicate using any known or future developed network protocol such as a HyperText Transfer Protocol (HTTP), and can intercommunicate and be interconnected with digital information in any form or medium (for example, a communication network). Examples of the communication network include a Local Area Network (LAN), a Wide Area Network (WAN), an internet (such as an Internet), a point-to-point network (such as an ad hoc point-to-point network, and any known or future developed network.

The computer-readable medium may be included in the head-mounted display device or exist alone and is not assembled into the head-mounted display device.

The above computer-readable medium carries one or more programs. Execution of the one or more programs by the head-mounted display device causes the head-mounted display device to:

enter a virtual reality space;

receive a media playing instruction triggered by a user, and display a playing page of a target multimedia file in the virtual reality space;

present a playing controlling panel in the virtual reality space, wherein the playing controlling panel includes a control region and a non-control region; and

present, in the non-control region, information related to the multimedia file.

When a multimedia file is presented in the head-mounted display device, a playing controlling panel is presented. The playing controlling panel includes a control region and a time progress controlling region of a target multimedia.

In response to an operation performed on the time progress controlling region of the target multimedia, a playing progress of the multimedia file is adjusted.

Alternatively, when one or more of the above programs are executed by the head-mounted display device, the head-mounted display device may further execute other steps of the above embodiments.

Computer program codes for performing the operations of the present disclosure may be written in one or more programming languages or a combination thereof. The above programming languages include but are not limited to an object-oriented programming language such as Java, Smalltalk, and C++, and conventional procedural programming languages such as “C” language or similar programming languages. The program codes may be executed entirely on a user computer, partly on a user computer, as a stand-alone software package, partly on a user computer and partly on a remote computer, or entirely on a remote computer or a server. In a case where a remote computer is involved, the remote computer can be connected to a user computer through any kind of networks, including a LAN or a WAN, or can be connected to an external computer (for example, through an Internet using an Internet service provider).

The flowcharts and block diagrams in the accompanying drawings illustrate possible system architectures, functions, and operations that may be implemented by a system, a method, and a computer program product according to various embodiments of the present disclosure. In this regard, each block in a flowchart or a block diagram may represent a module, a program, or a part of a code. The module, the program, or the part of the code includes one or more executable instructions used for implementing specified logic functions. In some implementations used as substitutes, functions annotated in blocks may alternatively occur in a sequence different from that annotated in an accompanying drawing. For example, actually two blocks shown in succession may be performed basically in parallel, and sometimes the two blocks may be performed in a reverse sequence. This is determined by a related function. It is also be noted that each box in a block diagram and/or a flowchart and a combination of boxes in the block diagram and/or the flowchart may be implemented by using a dedicated hardware-based system configured to perform a specified function or operation, or may be implemented by using a combination of dedicated hardware and a computer instruction.

The units described in the embodiments of the present disclosure can be implemented through software or hardware. The name of the unit does not constitute a limitation on the unit itself in a situation.

The functions described herein above may be performed, at least in part, by one or a plurality of hardware logic components. For example, nonrestrictively, example hardware logic components that can be used include: a Field Programmable Gate Array (FPGA), an Application Specific Integrated Circuit (ASIC), Application Specific Standard Parts (ASSP), a System on Chip (SOC), a Complex Programmable Logic Device (CPLD), and the like.

In the context of the present disclosure, a machine-readable medium may be a tangible medium that may include or store a program for use by an instruction execution system, apparatus, or device or in connection with the instruction execution system, apparatus. or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination of the above content. More specific examples of the machine-readable medium may include an electrical connection based on one or more wires, a portable computer disk, a hard disk drive, a RAM, a ROM, an EPROM or flash memory, an optical fiber, a CD-ROM, an optical storage device, a magnetic storage device, or any suitable combinations of the above contents.

According to one or more embodiments of the present disclosure, the present disclosure provides a head-mounted display device, including:

one or more processors;

a memory, configured to store one or more programs,

wherein the one or more programs, when run by the one or more processors, cause the one or more processors to implement any information presentation method provided by the present disclosure.

According to one or more embodiments of the present disclosure, the present disclosure provides a computer-readable storage medium, having a computer program stored thereon. The program, when run by a processor, implements any information presentation method provided by the present disclosure.

The embodiments of the present disclosure further provide a computer program product. The computer program product includes a computer program or instructions, and the computer program or instructions, when executed by a processor, implements the information presentation method as described above.

It should be noted that in this document, relationship terms such as “first” and “second” are used solely to distinguish one entity or operation from another entity or operation without necessarily requiring or implying any actual such relationship or order between such entities or operations. Furthermore, the terms “includes”, “including”, or any other variation thereof, are intended to encompass a non-exclusive inclusion, such that a process, method, article, or device that includes a list of elements does not include only those elements but may include other elements not explicitly listed or inherent to such process, method, article, or device. Without further limitation, an element defined by the phrase “including a/an . . . ” does not exclude the presence of another identical elements in the process, method, article or device that includes the element.

The above only describes the specific implementations of the present disclosure, which enables those skilled in the art to understand or implement the present disclosure. The various modifications to these embodiments will be apparent to those skilled in the art, and the general principles defined herein can be implemented in other embodiments without departing from the spirit or scope of the present disclosure. Thus, the present disclosure is not limited to these embodiments shown herein, but accords with the broadest scope consistent with the principles and novel features disclosed herein.

1. An information presentation method, wherein the method is applied to an extended reality (XR) terminal device, and the method comprises:
entering a virtual reality space;
receiving a media playing instruction triggered by a user to display a playing page of a target multimedia file in the virtual reality space;
presenting a playing controlling panel in the virtual reality space, wherein the playing controlling panel comprises a control region and a non-control region; and
presenting, in the non-control region, information related to the multimedia file.

2. The method of claim 1, wherein
the control region comprises at least two control sub-regions; any two control sub-regions are not connected; and at least one control is arranged in each of the control sub-regions.

3. The method of claim 1, wherein the non-control region and the control region are arranged on at the top and bottom or on the left and right.

4. The method of claim 3, wherein the non-control region comprises at least one of the following regions:
a time progress controlling region, content introduction region, associated content recommendation region, comment region, advertising region, and selection menu region of the target multimedia file.

5. The method of claim 4, wherein in response to detecting a preset operation performed on a target region in the non-control region, all the other regions of the playing controlling panel are forbidden to make feedback, and a response region of the target region is expanded to respond to a user operation performed on the target region.

6. The method of claim 1, further comprising:
in response to detecting a preset operation, switching the playing controlling panel to a control region that only comprises a single function.

7. The method of claim 1, wherein the method further comprises, in response to the multimedia file being a video, a projection mode of a video source being a full screen mode, and a length-width ratio of a video image in the video source being different from a length-width ratio of a video display region on the playing page of the target multimedia file:
aligning a center of the video image with a center of the video display region to maintaining the length-width ratio of the video image unchanged and enlarge the video image until a width of the video image is consistent with a width of the video display region and a length of the video image is less than a length of the video display region; or,
aligning a center of the video image with a center of the video display region to maintain the length-width ratio of the video image unchanged and enlarge the video image until a length of the video image is consistent with a length of the video display region and a width of the video image is less than a width of the video display region.

8. (canceled)

9. A head-mounted display device, wherein the head-mounted display device comprises:
one or more processors;
a memory apparatus, configured to store one or more programs, wherein the one or more programs, when executed by the one or more processors, cause the one or more processors to:
enter a virtual reality space;
receive a media playing instruction triggered by a user to display a playing page of a target multimedia file in the virtual reality space;
present a playing controlling panel in the virtual reality space, wherein the playing controlling panel comprises a control region and a non-control region; and
present, in the non-control region, information related to the multimedia file.

10. A non-transitory computer-readable storage medium, having a computer program stored thereon, wherein the program, when executed by a processor, cause the processor to:
enter a virtual reality space;
receive a media playing instruction triggered by a user to display a playing page of a target multimedia file in the virtual reality space;
present a playing controlling panel in the virtual reality space, wherein the playing controlling panel comprises a control region and a non-control region; and
present, in the non-control region, information related to the multimedia file.

11. The device of claim 9, wherein
the control region comprises at least two control sub-regions; any two control sub-regions are not connected; and at least one control is arranged in each of the control sub-regions.

12. The device of claim 9, wherein the non-control region and the control region are arranged on at the top and bottom or on the left and right.

13. The device of claim 12, wherein the non-control region comprises at least one of the following regions:
a time progress controlling region, content introduction region, associated content recommendation region, comment region, advertising region, and selection menu region of the target multimedia file.

14. The device of claim 13, wherein in response to detecting a preset operation performed on a target region in the non-control region, all the other regions of the playing controlling panel are forbidden to make feedback, and a response region of the target region is expanded to respond to a user operation performed on the target region.

15. The device of claim 9, wherein the device is further caused to:
in response to detecting a preset operation, switch the playing controlling panel to a control region that only comprises a single function.

16. The device of claim 9, wherein the device is further caused to, in response to the multimedia file being a video, a projection mode of a video source being a full screen mode, and a length-width ratio of a video image in the video source being different from a length-width ratio of a video display region on the playing page of the target multimedia file:
align a center of the video image with a center of the video display region to maintaining the length-width ratio of the video image unchanged and enlarge the video image until a width of the video image is consistent with a width of the video display region and a length of the video image is less than a length of the video display region; or,
align a center of the video image with a center of the video display region to maintain the length-width ratio of the video image unchanged and enlarge the video image until a length of the video image is consistent with a length of the video display region and a width of the video image is less than a width of the video display region.

17. The medium of claim 10, wherein
the control region comprises at least two control sub-regions; any two control sub-regions are not connected; and at least one control is arranged in each of the control sub-regions.

18. The medium of claim 10, wherein the non-control region and the control region are arranged on at the top and bottom or on the left and right.

19. The medium of claim 18, wherein the non-control region comprises at least one of the following regions:
a time progress controlling region, content introduction region, associated content recommendation region, comment region, advertising region, and selection menu region of the target multimedia file.

20. The medium of claim 19, wherein in response to detecting a preset operation performed on a target region in the non-control region, all the other regions of the playing controlling panel are forbidden to make feedback, and a response region of the target region is expanded to respond to a user operation performed on the target region.

21. The medium of claim 10, wherein the processor is further caused to further:
in response to detecting a preset operation, switch the playing controlling panel to a control region that only comprises a single function.
